(19) United States
(12) Patent Application Publication
(10) Pub. No.: US 2005/0280171 A1
(43) Pub. Date: Dec. 22, 2005

(54) Mold for diffractive aspheric lenses and method for making the mold

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/141,098

(22) Filed: May 31, 2005

(30) Foreign Application Priority Data
Jun. 17, 2004 (CN) 200410027765.0

(51) Int. Cl. B29D 11/00

(52) U.S. Cl. 264/2.5; 249/135; 425/808

(57) ABSTRACT

A mold (1) for diffractive aspheric lenses includes a substrate portion (10), and a pattern layer portion (12) formed integrally with the substrate. The pattern layer portion has a plurality of diffraction strias (120). A method for making the mold includes: 1) providing a substrate having an aspheric surface; 2) coating a photoresist layer on the aspheric surface; 3) lithographing a pattern on the photoresist layer, thereby creating two kinds of portions in the photoresist layer; 4) exposing one of the two kinds of portions of the photoresist layer; 5) developing the mold to dissolve unexposed portions of the photoresist layer; 6) etching the substrate between remaining portions of the photoresist layer; 7) removing the remaining portions of the photoresist layer and cleaning the substrate, thereby providing the mold.

### FIELD OF THE INVENTION

The present invention generally relates to molds for lenses, and more particularly to a mold for making diffractive aspheric lenses and a method for making the mold itself.

### BACKGROUND

As multimedia technology continues to develop rapidly, digital still cameras (“still cameras”) and digital video cameras (“video cameras”) are becoming more and more popular. Consumers expect the size of modern still cameras and video cameras to be small, while still providing high quality images. One key determinant of the quality of the images is the lens employed in the particular digital device.

Parallel light that passes through a typical spherical lens cannot focus on one point. This problem is known as spherical aberration, and results in blurry images. In addition, light with different wavelengths tends to focus on different points. This problem is known as chromatic aberration. Commonly, a plurality of lens pieces is employed to solve or at least ameliorate the problem of spherical aberration. However, this is achieved at the cost of enlarging the size of the still camera or video camera. In contrast, a still camera or video camera equipped with a single aspheric lenses can also address the problem of spherical aberration. Such still cameras and video cameras are relatively small, and the aspheric lens can focus the light on one point and eliminate or minimize spherical aberration. Further, a diffractive aspheric lens can also solve or ameliorate the problem of chromatic aberration. Thus a diffractive aspheric lens is considered by many to be necessary for attaining a small, high-quality still camera or video camera.

A typical method for making a diffractive aspheric lens comprises the following steps: plating a film on a substrate of a lens by Plasma Enhanced Chemical Vapor Deposition (PECVD) or Chemical Vapor Deposition (CVD); coating a layer of photoresist on the film; exposing the lens to lithograph a pattern on the photoresist by using a laser; developing the lens in a developer to remove a part of the photoresist; fixing the pattern; and etching the film according to the pattern of the photoresist.

However, the above-described method for making a diffractive aspheric lens is rather complex. In addition, a plurality of the lenses can only be manufactured one by one. This makes it difficult to streamline and automate the production process, and is liable to result in inconsistent quality of lenses being produced. The upshot is low efficiency and high costs.

What is needed, therefore, is a mold for streamlining the manufacture of diffractive aspheric lenses, and a method for making such mold.

### SUMMARY

A mold for diffractive aspheric lenses comprises a substrate portion and a pattern layer portion adjacent the substrate portion. The pattern layer portion includes a plurality of diffraction strias.

A method of making the mold comprises: 1) providing a substrate having an aspheric surface; 2) coating a photoresist layer on the aspheric surface; 3) lithographing a pattern on the photoresist layer, thereby creating two kinds of portions in the photoresist layer; 4) exposing one of the two kinds of portions of the photoresist layer; 5) developing the mold to dissolve unexposed portions of the photoresist layer; 6) etching the substrate between remaining portions of the photoresist layer; and 7) removing the remaining portions of the photoresist layer and cleaning the substrate, thereby providing the mold.

In use of the mold, preforms can be put into the mold and be pressed and heated to form aspheric lenses. Alternatively, a diffractive aspheric lens can be formed in the mold 1 by an injection process. Either way, the manufacturing process is relatively simple, and the quality of the diffractive aspheric lenses produced is consistent.

Other advantages and novel features of preferred embodiments of the present invention will become more apparent from the following detailed description when taken in conjunction with the accompanying drawings, in which:

### BRIEF DESCRIPTION OF THE DRAWINGS

FIG. 1 is a cross-sectional view of a substrate having a photoresist layer coated on an aspheric surface thereof, in accordance with a preferred embodiment of the present invention;

FIG. 2 is similar to FIG. 1, but showing the photoresist layer after developing thereof;

FIG. 3 is similar to FIG. 2, but showing the substrate and the photoresist layer after etching of the substrate has been performed; and

FIG. 4 is similar to FIG. 3, but showing the substrate in isolation after the photoresist layer has been removed, the substrate constituting a mold in accordance with a preferred embodiment of the present invention.

### DETAILED DESCRIPTION OF PREFERRED EMBODIMENTS

Referring to FIG. 4, a mold 1 for diffractive aspheric lenses in accordance with a preferred embodiment of the present invention comprises a substrate portion 11 and a pattern layer portion 12 for diffraction. The pattern layer portion 12 is formed integrally with the substrate portion 11, and comprises a plurality of elevated diffraction strias 120. The diffraction strias 120 match corresponding diffraction strias of each diffractive aspheric lens that is produced using the mold 1. The mold 1 can be made of any of various super-hard metals or alloys such as stainless steel, super-hard steel, or nickel phosphide (NiP). The mold 1 can also be made of any of various hard ceramic materials such as silicon carbide (SiC) or tungsten carbide (WC).

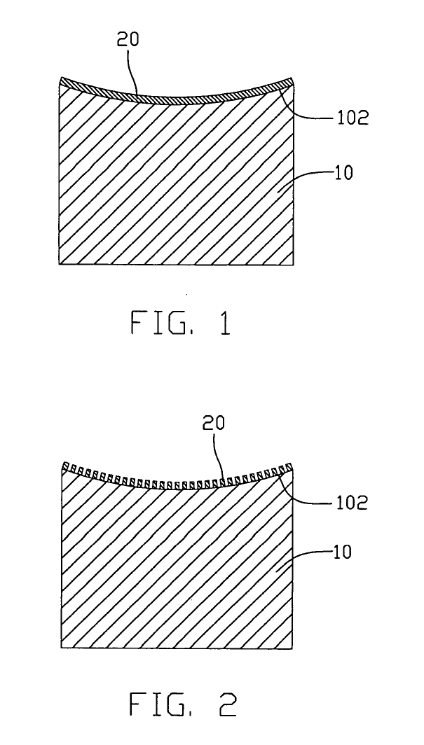

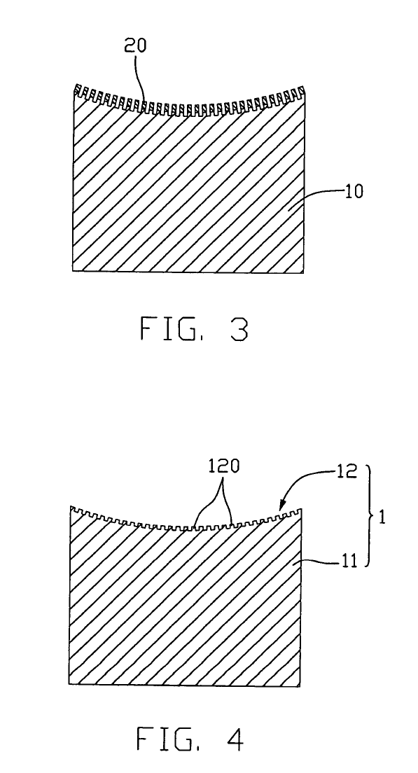

Referring to FIGS. 1-3, a process for making the mold 1 comprises the following steps. Firstly, an initial concave, aspheric surface 102 of the substrate 10 is cleaned. A priming (not shown) made of Silane Coupling Reagent or the like is coated on the aspheric surface 102. A photoresist layer 20 is coated on the primed aspheric surface 102. Then the mold 1 is baked for five to ten minutes under a temperature of 50˜150° C. to improve the sensitivity of the photoresist layer 20.

Next, a pattern corresponding to outlines of the diffraction strias 120 of the pattern layer portion 12 is lithographed on the photoresist layer 20, by way of dry etching using an electron-beam. A wavelength of the electron-beam is 0.04˜10 nm, and an acceleration voltage of the electron-beam is 50˜3000 KeV. The pattern of the photoresist layer 20 thus formed comprises two kinds of linear portions arranged parallel to each other in alternate fashion: raised portions and recessed portions. The raised portions are covered by a photo mask (not shown), and the recessed portions are exposed to laser or ultraviolet radiation. Then the duly exposed mold 1 is immersed in a developer to develop the photoresist layer 20. As a result, the unexposed raised portions of the photoresist layer 20 are dissolved, and only the exposed recessed portions of the photoresist layer 20 remain. The developer can be an inorganic alkaline liquid or an organic alkaline liquid. The inorganic alkaline liquid can be selected from the group consisting of sodium phosphate, calcium phosphate, sodium hydroxide, and calcium hydroxide.

Then exposed parts of the aspheric surface 102 of the substrate 10 that are not covered by the remaining photoresist layer 20 are etched, which is performed by way of reactive ion etching or magnetron enhanced reactive ion etching. The substrate 10 is immersed in concentrated acid to remove the remaining photoresist layer 20 and thereby completely expose the duly formed diffraction strias 120. Finally, remaining concentrated acid is rinsed out, thereby providing the mold 1 with the pattern layer portion 12.

If the mold 1 is made of a hard ceramic material such as silicon carbide (SiC) or tungsten carbide (WC), a surface of the pattern layer portion 12 has a diamond-like carbon (DLC) film thereon. The DLC film enhances the lubrication characteristics of the pattern layer portion 12.

In use of the mold 1, a preform can be put into the mold 1 touching the diffraction strias 120. The preform is pressed and heated to form a diffractive aspheric surface of the desired diffractive aspheric lens. Alternatively, a diffractive aspheric lens can be formed in the mold 1 by an injection process. Either way, the manufacturing process is relatively simple, and the quality of the diffractive aspheric lenses produced is consistent.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A mold for diffractive aspheric lenses, comprising:
a substrate portion; and
a pattern layer portion adjacent the substrate portion, the pattern layer portion comprising a plurality of diffraction strias.

2. The mold as claimed in claim 1, wherein the mold comprises a super-hard metal or alloy.

3. The mold as claimed in claim 2, wherein the super-hard metal or alloy is selected from the group consisting of stainless steel, super-hard steel, and nickel phosphide.

4. The mold as claimed in claim 1, wherein the mold comprises hard ceramic material.

5. The mold as claimed in claim 4, wherein the hard ceramic material is selected from the group consisting of silicon carbide (SiC) and tungsten carbide (WC).

6. The mold as claimed in claim 4, wherein the pattern layer portion has a diamond-like carbon film portion.

7. The mold as claimed in claim 1, wherein the diffraction strias match diffraction strias of a diffractive aspheric lens producible by using the mold.

8. A method for making a mold for diffractive aspheric lenses, comprising the steps of:
providing a substrate having an aspheric surface;
coating a photoresist layer on the aspheric surface;
lithographing a pattern on the photoresist layer, thereby creating two kinds of portions in the photoresist layer;
exposing one of the two kinds of portions of the photoresist layer;
developing the mold to dissolve unexposed portions of the photoresist layer;
etching the substrate between remaining portions of the photoresist layer; and
removing the remaining portions of the photoresist layer, and cleaning the substrate, thereby providing the mold.

9. The method as claimed in claim 8, wherein the pattern is lithographed by an electron-beam.

10. The method as claimed in claim 9, wherein a wavelength of the electron-beam is in the range from 0.04˜10 nm, and an acceleration voltage of the electron-beam is 50˜3000 KeV.

11. The method as claimed in claim 8, wherein a priming comprising Silane Couping Reagent is coated on the aspheric surface before the photoresist layer is coated on the aspheric surface.

12. The method as claimed in claim 8, wherein the mold with the photoresist layer is baked for five to ten minutes under a temperature of 50˜150° C. before lithographing.

13. The method as claimed in claim 8, wherein the two kinds of portions of the photoresist layer are raised portions and recessed portions, the raised portions are covered by a photo mask, and the recessed portions are exposed to laser or ultraviolet radiation.

14. The method as claimed in claim 8, wherein the developer is an inorganic alkaline liquid or an organic alkaline liquid.

15. The method as claimed in claim 13, wherein the inorganic alkaline liquid is selected from the group consisting of sodium phosphate, calcium phosphate, sodium hydroxide, and calcium hydroxide.

16. The method as claimed in claim 8, wherein the pattern is lithographed by a method of dry etching.

17. A method for making a diffractive aspheric lens, comprising the steps of:
preparing a mold having a pattern portion corresponding to a diffractive aspheric surface of said diffractive aspheric lens by means of etching said mold to form said pattern portion;
placing a preform readily to transform to said diffractive aspheric lens beside said mold facing said pattern portion;
forming said diffractive aspheric lens along said pattern portion of said mold by means of pressuring said mold upon said preform for generating said diffractive aspheric surface on said preform; and
removing said mold from said perform so as to acquire said diffractive aspheric lens.

18. The method as claimed in claim 17, further comprising the step of using a photoresist layer readily to be lithographed on said mold before etching for forming said pattern portion of said mold.

19. The method as claimed in claim 17, wherein said preform is placed beside said mold by means of injection processing.
